(19) United States
(12) Patent Application Publication
(10) Pub. No.: US 2009/0006568 A1
(43) Pub. Date: Jan. 1, 2009

(54) Network-based collaboration record

(75) Inventors: Oliver Messenger, Seattle, WA (US); Ned Friend, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/823,661

(22) Filed: Jun. 28, 2007

(51) Int. Cl. G06F 15/16

(52) U.S. Cl. 709/206

(57) ABSTRACT

A network-accessible data storage service integrated with instant messenger software. Network-based collaboration between one or more collaborators may be facilitated by enabling information exchanged in an instant messaging environment, such as files and comments, to be integrated into a network-accessible data storage service and made available to the one or more collaborators after collaboration in the instant messaging environment has ended. In some embodiments of the invention, a data storage service may comprise an instant messaging service through which the data storage service may be a collaborator. Information exchanged during the network-based conversations may be received by the data storage service as if it were one of the one or more collaborators and may be stored by the data storage service in a network-accessible location. The data may then be made available to the one or more collaborators of the network-based collaboration following the end of the network-based collaboration.

### BACKGROUND OF INVENTION

In recent years, network-based collaboration between two or more collaborators remote to one another has grown in popularity. Network-based collaboration systems of different types are known.

In a first type, a document on which collaborators are collaborating may be stored in a location from which it may be accessed and edited by one or more collaborators, such as in a shared file service. An example of a collaboration system of this type is Office Live® Workspace service, available from the Microsoft Corporation of Redmond, Wash. The document may be edited by a collaborator, and an edited version of the document may be made available to other collaborators.

In a second type, collaborators may exchange comments with one another. Two or more collaborators, each using computer software such as the Windows® Messenger™ software, available from the Microsoft Corporation, on a computing device, may exchange text-based comments with one another in a chat session. In some chat sessions, collaborators may exchange a document and may make comments related to the exchanged document. The exchanged document may then be updated by one or more collaborators according to the comments and updated versions of the document may be exchanged between the collaborators.

In a third type, collaborators may each store a version of a document on which they are collaborating locally (i.e., on a computer-readable storage medium on each collaborator's computing device). Each collaborator may enter edits into the document, and the edits may be transmitted to other collaborators' computing devices as the edits are entered. Edits received by other collaborators' computing devices may then be automatically entered into the document stored on that computing device. In this way, each collaborator may have at all times a current version of a document on which he or she is collaborating. An example of a collaboration system of this type is the Office Groove collaboration software program, available from the Microsoft Corporation.

### SUMMARY OF INVENTION

Network-based collaboration between one or more collaborators may be facilitated by enabling information exchanged in an instant messaging environment, such as files and comments, to be integrated into a network-accessible data storage service and made available to the one or more collaborators after collaboration in the instant messaging environment has ended. One example of network-based collaboration is network-based conversations. In some embodiments of the invention, a data storage service may comprise an instant messaging service allowing collaborators to collaborate in a network-based conversation in which the data storage service may be a collaborator. Information exchanged during a network-based conversation may be received by the data storage service as if it were one of the collaborators and may be stored by the data storage service in a network-accessible location. The data may then be made available to the collaborators of the network-based collaboration following the end of the network-based collaboration.

In one embodiment, there is provided a method of operating a collaboration system comprising a workspace of a data storage service and an instant messaging agent to allow at least one collaborator to share information. The method comprises establishing an instant messaging agent associated with the workspace as a collaborator in a chat session and sharing the information among the at least one collaborator and the instant messaging agent. The method further comprises storing, with the instant messaging agent, the information in association with the workspace.

In another embodiment, there is provided a method of operating a collaboration system comprising a server and a plurality of client computers. The method comprises establishing a workspace on the server for a collaborator using the collaboration system and establishing an instant messaging chat session including instant messaging clients on the plurality of client computers and an instant messaging agent that has access to the workspace on the server. The method further comprises capturing, with the instant messaging agent, information exchanged in the chat session and storing the information exchanged in the chat session on the server associated with the workspace.

In a further embodiment, there is provided computer-readable media having computer-executable instructions for implementing a collaboration system allowing collaboration among at least one collaborator. The computer-executable instructions, when executed, perform steps. The steps comprise maintaining a workspace on a server under control of a workspace user that is a collaborator of the at least one collaborator. The workspace provides storage for a plurality of artifacts accessible to the workspace user and secondary users designated by the workspace user. The steps further comprise broadcasting real-time messages between the at least one collaborator, automatically capturing and storing the real-time messages in the storage of the workspace, and designating at least a portion of the at least one collaborators as secondary users of the workspace.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram of an exemplary computer system in which some embodiments of the invention may act;

FIG. 2 is a flowchart of an illustrative process for a chat participant to carry out a network-based conversation in accordance with some embodiments of the invention;

FIG. 3 is a flowchart of an illustrative process for a data storage service to monitor a network-based conversation in accordance with some embodiments of the invention;

FIG. 4 is a screenshot of an illustrative implementation of a user interface for a data storage service in accordance with some embodiments of the invention;

FIG. 5 is another screenshot of an illustrative implementation of a user interface for a data storage service in accordance with some embodiments of the invention;

FIG. 6 is a diagram of an exemplary computing device that may be used as an instant messaging client in accordance with some embodiments of the invention;

FIG. 7 is a diagram of an exemplary computing device that may be used as an instant messaging server in accordance with some embodiments of the invention; and

FIG. 8 is a diagram of an exemplary computing device that may be used as a data storage server in accordance with some embodiments of the invention.

### DETAILED DESCRIPTION

Conventional instant messaging software has been limited to storing records of chat sessions locally on one chat participant's computing device or on each chat participants' computing device. In such conventional systems, if a chat participant wanted to make a record of a chat session available to other collaborators, the chat participant would have to e-mail the locally-stored record to the other collaborators or upload manually the locally-stored record to a server from which it would be retrievable by the other collaborators. Further, if during a chat session a document were to be exchanged between collaborators, conventional instant messaging clients are limited to storing the exchanged document separate from the chat session related to the exchanged document.

Applicants have appreciated that collaboration may be facilitated if records of network-based conversations such as chat sessions in an instant messaging environment were to be automatically stored in a shared location, and have appreciated that a data storage service may be adapted to monitor a network-based conversation and store information exchanged during the network-based conversation in a location at which it may be made available to other collaborators. Applicants have also appreciated that collaboration may be facilitated if information exchanged during the network-based conversation were stored in a format that links the exchanged information, including documents and comments, together in a logical format.

In view of the foregoing, one embodiment of the present invention is directed to a network-accessible data storage service integrated with instant messaging software such that the data storage service may be a participant in a network-based conversation. In some embodiments of the invention, a data storage service may comprise an instant messaging agent through which the data storage service may be a participant in network-based conversations. Data exchanged during the chat sessions, such as documents and comments, may be received by the data storage service and stored in a network-accessible location.

The invention is not limited to being implemented with any particular type of network-based conversation, as embodiments of the invention may operate with any suitable type of network-based conversation. Types of network-based conversations include, but are not limited to, chat sessions and instant message sessions. Exemplary implementations of embodiments of the invention are described below. In some exemplary implementations described, the network-based conversation may be described as a chat session, however, it should be appreciated that embodiments of the invention are not limited to being implemented with chat sessions and may be implemented with any suitable type of network-based conversation.

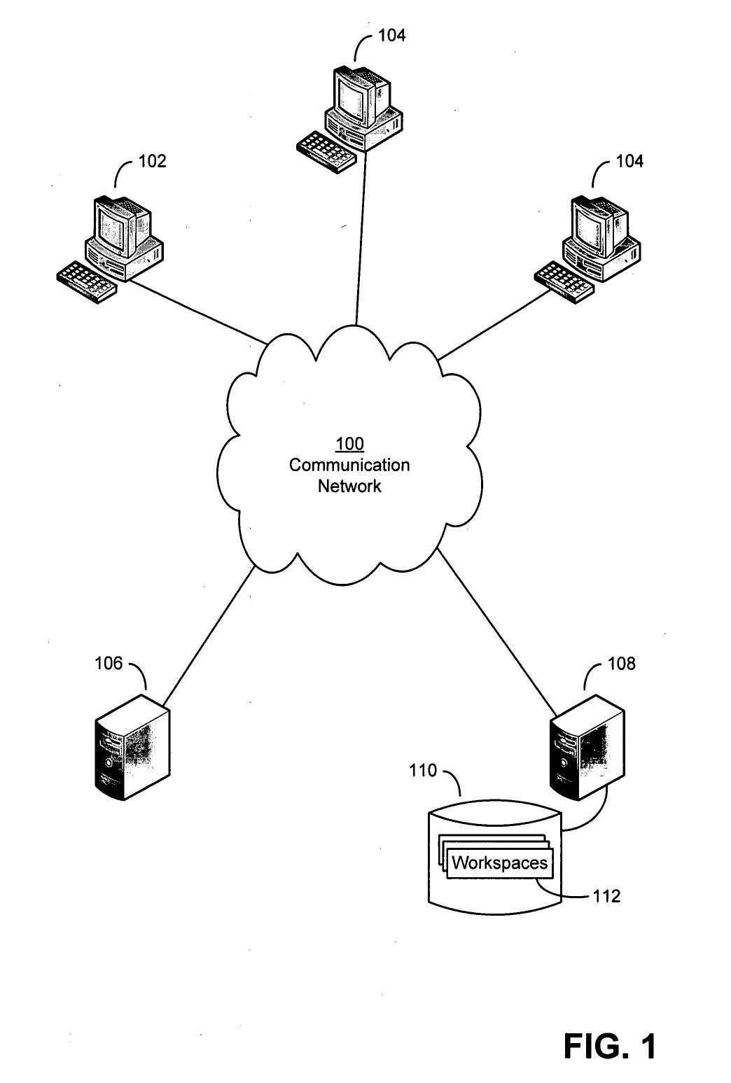

The aspects of the present invention described herein can be implemented on any of numerous computer system configurations and are not limited to any particular type of configuration. FIG. 1 illustrates one example of a computer system on which a collaboration system can be implemented in accordance with embodiments of the invention, although others are possible.

In the exemplary computer system shown in FIG. 1, a collaboration system comprises a plurality of collaborators each having their own computing devices 102 and 104 are connected to a communication network 100. Communication network 100 may be any suitable wired and/or wireless communication medium or media for exchanging information (e.g., data and/or instructions) between two or more computing devices, including the Internet and/or an enterprise network. A computing device such as computing devices 102 and 104 may be any suitable computing device for communicating (i.e., sending and/or receiving information) over communication network 100, such as a desktop personal computer, a laptop personal computer, a personal digital assistant, a smart mobile phone, or any other suitable computing device.

Collaborators may exchange information with one another as part of a network-based conversation. Such a conversation may be performed in any suitable way. For example, collaborators may use collaboration software such as instant messaging software installed and executed on a client machine or web-based instant messaging software accessed via a web browser on a client machine. In embodiments of the invention, information exchanged between collaborators may be broadcast or multicast directly from a transmitting collaborator's computing device (e.g., computing device 102) to receiving collaborators' computing devices (e.g., computing devices 104), while in other embodiments of the invention the information may be sent to an instant messaging server for processing before being relayed to receiving collaborators' computing devices. In the embodiments of the invention that include an instant messaging server hosting instant messaging software to process and relay the information, the collaboration system may include an instant messaging server 106.

As discussed above, in embodiments of the invention a collaboration system further comprises a data storage service integrated with the instant messaging software such that the data storage service receives the information sent by the collaborators just as any other collaborator would and stores it in a network-accessible location such that it may be accessed by collaborators. In the embodiments of the invention implementing such a data storage service, data storage server 108 may be included in the collaboration system. Data storage server 108 may have a plurality of particular data stores (e.g., workspaces 112) logically organizing the information sent by the collaborators and other information received by the data storage server 108. Workspaces 112 stored by the data storage server 108 may be associated with one or more collaborators and may store information received by the data storage server 108 (e.g., files) from the collaborator in any suitable format or structure. A collaborator may be associated with (e.g., be an owner of) one or more workspaces of the workspaces 112, and a workspace of the workspaces 112 may be in whole or in part associated with one or more collaborators (i.e., all the information stored in a workspace may be associated with one or more collaborators, or one or more files stored by a workspace may be associated with one or more collaborators while one or more other files stored by the workspace may be associated with one or more other collaborators). Instant messaging server 106 and data storage server 108 may be implemented as any suitable computing device or may be implemented as a group of computing devices sharing processing and storage resources, or may be implemented in any other suitable manner.

Exemplary implementations of computing devices 102 and 104, instant messaging server 106, and data storage server 108 are discussed in greater detail below. It should be appreciated that embodiments of the invention are not limited to being implemented on or with the exemplary collaboration system and/or the exemplary computer system shown in FIG. 1, as embodiments of the invention may be implemented on or with any suitable collaboration system and/or computer system.

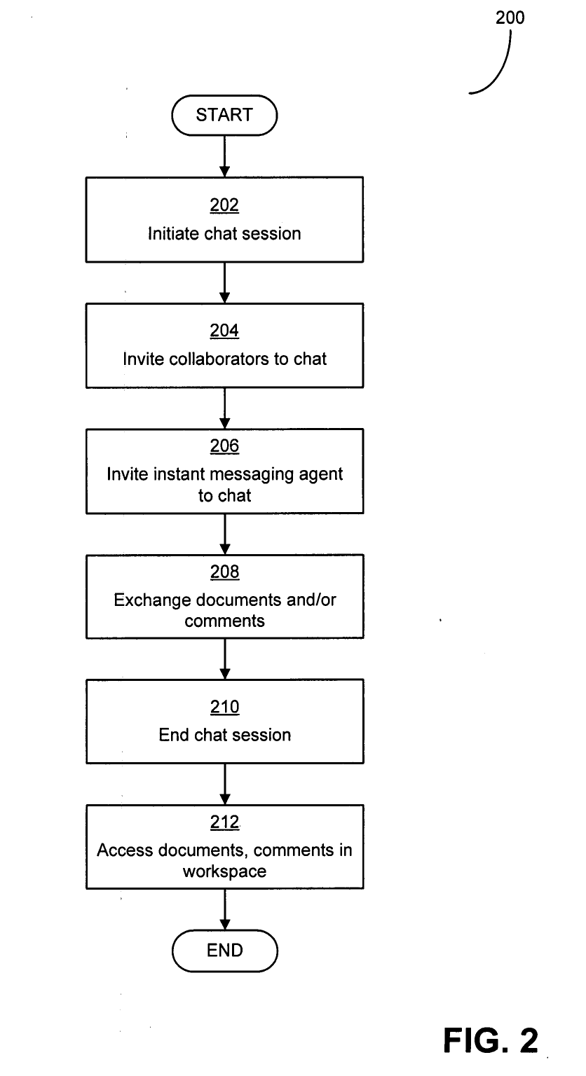

FIG. 2 shows an exemplary process 200 for a collaborator to exchange information in a collaboration system such as the one shown in FIG. 1. It should be appreciated that the invention is not limited to implementing the exemplary process 200, as embodiments of the invention may operate on the collaboration system of FIG. 1 in any suitable manner.

The process 200 starts in block 202, when a first collaborator initiates a chat session in the collaboration system using instant messenger software. In the collaboration system of FIG. 1, the first collaborator may be operating computing device 102. Initiating a chat session may be done in any suitable manner, such as by notifying the instant messaging server 106 in any suitable way of a desire to initiate a chat session. When the instant messaging server 106 receives a notification that a collaborator would like to initiate a chat session, the instant messaging server 106 may allocate resources such as processing and storage resources to the chat session.

Once the chat has been initiated in block 202, in block 204 the first collaborator invites one or more other collaborators, such as operators of computing devices 104, to the chat session. Inviting collaborators to a chat session may be done in any suitable manner. In some embodiments of the invention, a collaborator may be invited to a chat session when the first collaborator communicates to the instant messaging server 106 an indicator associated with a collaborator, such as a name of the collaborator or any other suitable unique identifier. In some embodiments of the invention, to participate in a chat session, a collaborator may be required to have an account with an instant messaging service, and the account may be associated with a unique username for the instant messaging service. The unique username may be any suitable unique identifier and may be, for example, an e-mail address for the collaborator. In some embodiments of the invention implemented on a collaboration system using the Windows® Messenger™ software, the unique username for a collaborator may be a Passport Unique Identifier (PUID) for the collaborator.

When the instant messaging server 106 receives an invitation for a collaborator, it may then transmit an indicator to a computing device 104 that the collaborator is operating. The indicator may signal that the collaborator has been invited to participate in a chat session. If the collaborator accepts the invitation to join the chat session, then the instant messaging server 106 may add the indicator associated with the collaborator and/or an indicator associated with the collaborator's computing device 104 to a data store associated with the chat session which the instant messaging server 106 uses to determine to which computing devices (i.e., collaborators) it should relay communications received as part of a chat session.

After inviting one or more other collaborators to participate in a chat session, the first collaborator (or any other collaborator participating in the chat session) may establish a connection between the instant messaging system and a network-accessible data storage service. The established connection may be, in some embodiments of the invention, a connection to a workspace stored by the data storage service. The connection may be established in any suitable way, such as by using the protocol of the instant messaging system such that the data storage service becomes a participant in the chat session and receives information exchanged during the chat session just as any other participant would receive the information.

For example, in block 206 a collaborator may invite an instant messaging agent associated with a data storage service to participate in the chat session as a collaborator. It should be appreciated that inviting an instant messaging agent as in block 206 may comprise inviting one or more instant messaging agents associated with a data storage service to participate in the chat session. The instant messaging agent(s) may be executing on the data storage server 108. In some embodiments of the invention, an instant messaging agent may be associated with a workspace that is associated with one or more of the collaborators participating in the chat session. In other embodiments of the invention, the instant messaging agent may be associated with a collaborator that is participating in the chat session, and inviting the instant messaging agent to participate in the chat session may comprise sending an indicator to the instant messaging agent of in which workspace the information collected during the chat session should be stored. Inviting an instant messaging agent to participate in a chat session may also comprise transmitting an indicator to an instant messaging agent that it should create a workspace and associate it with one or more collaborators indicated in the indicator, and that the instant messaging agent should store the information collected during the chat session in the created workspace.

It should be appreciated that, in some embodiments of the invention, only a collaborator who is associated with an instant messaging agent may invite an instant messaging agent to participate in a chat session. In alternative embodiments of the invention, any collaborator may invite any instant messaging agent to participate in the chat session or an instant messaging agent may store a listing of collaborators having permission to invite the instant messaging agent to participate in a chat session. In this way, if a collaborator were not available to participate in a chat session (e.g., the collaborator is vacationing, ill, in a meeting, etc.), other collaborators may invite an instant messaging agent associated with the absent collaborator to participate in a chat session such that the absent collaborator may review the information (e.g., comments and files) exchanged during the chat session.

In block 208, the collaborators participating in the chat session exchange information (e.g., one or more comments and/or one or more documents) with one another. As described above, in embodiments of the invention, the instant messaging agent that was invited to participate in the chat session receives the information exchanged during the chat session and stores it in the workspace associated with the instant messaging agent. Exemplary methods of storing information in the workspace are discussed in greater detail below.

In block 210, after the collaborators have exchanged information, the chat is ended by a collaborator in any suitable way. A chat session may be ended when live collaborators (collaborators other than instant messaging agents) have disconnected from the chat session (e.g., when all or all but one collaborators have disconnected), or may be ended when a collaborator indicates to the instant messaging server 106 that the chat session should be terminated. Following the end of the chat session, in block 212 the information exchanged during the chat session (comments and/or documents) may be accessed by the collaborators in the workspace in which the instant messaging agent stored the information.

It should be appreciated that some embodiments of the invention are not limited to implementing the exemplary process shown in FIG. 2 and that embodiments of the invention may implement any suitable process for exchanging information in a chat session. For example, some embodiments of the invention may implement a process 200 that does not include or makes optional the process of block 204 to invite other collaborators to a chat session. In such embodiments, the process 200 may be implemented such that the first collaborator may communicate only with the instant messaging client, which stores data it receives from the first collaborator in the workspace. Additionally, in some embodiments of the invention, a process 200 may be implemented such that multiple instant messaging agents may be invited to participate in the chat session and each may store information exchanged between collaborators in a workspace. This may be done to permit each collaborator to invite an instant messaging agent associated with his or her workspace(s) to store the information. It should be further appreciated that in some embodiments of the invention, the information exchanged during a chat session may comprise only documents or only comments, and as such, some embodiments of the invention may implement accordingly block 208 of process 200.

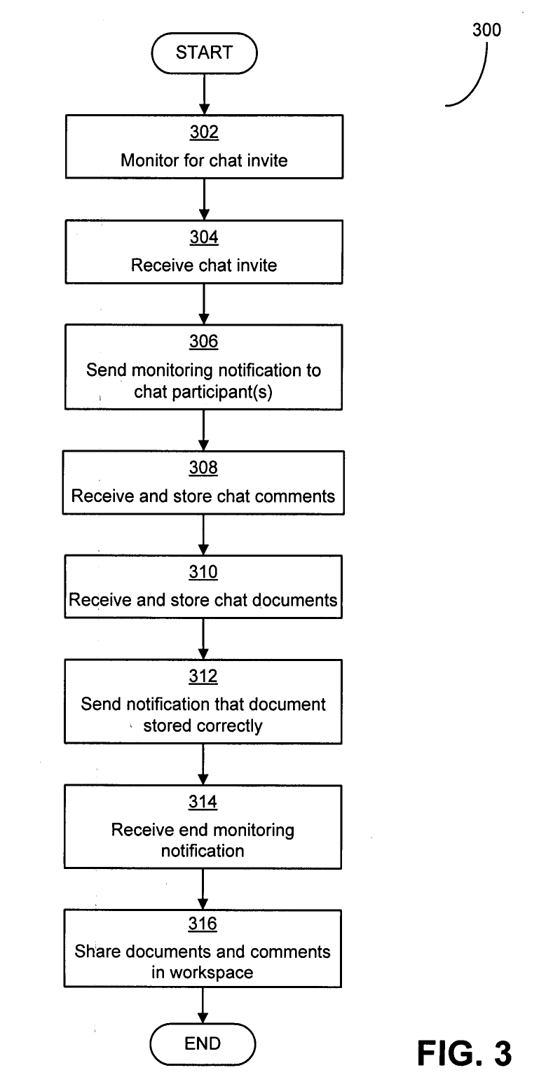

FIG. 3 shows an exemplary process 300 that may be performed by an instant messaging agent to monitor a chat session and store information exchanged between collaborators during the chat session in accordance with some embodiments of the invention. It should be appreciated that the invention is not limited to implementing the illustrative process shown in FIG. 3 and that embodiments of the invention may implement any suitable process for monitoring a chat session and storing the information exchanged.

The process 300 begins in block 302 when the instant messaging agent begins monitoring for an invitation to a chat session. This may be done in any suitable manner, such as by monitoring a communications port on the data storage server 108 of FIG. 1 for a chat invitation from a collaborator's computing device 102 or 104 of FIG. 1 or from the instant messaging server 106 of FIG. 1. In block 304, the process detects that a chat invitation has been received, and, in block 306, may transmit a notification to one or more collaborators participating in the chat session that it is monitoring the chat session. This notification may be sent to all collaborators participating in the chat session, may be sent only to the collaborator who invited the instant messaging agent to the chat session, or may be sent to any other suitable collaborator or group of collaborators. In alternative embodiments of the invention, the data storage server may instead create an instant messaging agent to monitor a chat session to which it has been invited when it receives the chat invitation, rather than executing an instant messaging agent that is waiting for a chat invitation.

Once the instant messaging agent begins monitoring the chat session, it may begin receiving and storing information received during the chat session. Information exchanged during a chat session may be any suitable type of information, and may be stored in any suitable manner. In block 308, the instant messaging agent begins to receive information in the form of one or more comments (e.g., text-based messages) and stores the one or more comments in the workspace. Storing comments may comprise storing the text of the comment as well as any suitable information about the comment, such as the name of the collaborator who sent the comment and the time the comment was sent. In block 310, the instant messaging agent receives one or more documents exchanged between the collaborators and stores the one or more documents in the workspace. After receiving and storing one or more documents in block 310, the instant messaging agent may, in block 312, transmit to the collaborators participating in the chat session an indicator notifying the collaborators that the one or more documents were successfully or unsuccessfully stored by the instant messaging client in the workspace. Types of information other than documents and/or comments exchanged during a chat session may be received any stored in any suitable manner.

In block 314, the instant messaging client receives a notification that it should stop monitoring the chat session. The notification may be received from a collaborator participating in the chat session, such as the collaborator that invited the instant messaging agent to the chat session. Alternatively, the notification may be sent by the instant messaging server 106. The notification may be structured in any suitable way and contain any suitable information. In some embodiments of the invention, the notification may be a notification that the chat session has ended while in others it may be a notification that it should stop monitoring the chat session.

In block 316, after receiving a notification to stop monitoring the chat session, the instant messaging client commits the information received during monitoring to the workspace. Information may be committed to the workspace in any suitable manner, as the invention is not limited to storing the information in any specific way and embodiments of the invention may store the information in any suitable manner. In some embodiments of the invention, the manner in which the information is stored may depend on the information that was exchanged during the chat session. If one document and a plurality of comments were exchanged during the chat session, then the instant messaging agent may determine that the comments were made with regard to the one document and may store the one document in the workspace associated with the comments exchanged during the chat session. If no documents were exchanged and a plurality of comments were exchanged, then the plurality of comments may be stored as a document in the workspace. If a plurality of documents and a plurality of comments were exchanged during the chat session, then the instant messenger agent may store each document of the plurality of documents in the workspace and store the plurality of comments as another document in the workspace. In some embodiments of the invention, the instant messenger agent may detect whether a plurality of documents exchanged during a chat session are different versions of a single document, and store the last exchanged version of the document in the workspace associated with the comments exchanged during the chat session. The instant messenger agent may be able to detect this based on a unique identifier that has been assigned to a document or may detect it based on a notification received from the collaborator transmitting the document that the document is an updated version of a previously-exchanged document. It should be appreciated that these exemplary storage techniques are merely illustrative, and other storage techniques are possible.

Once the information has been saved to the workspace in block 316, then the information may, in some embodiments of the invention, be automatically shared with (e.g., made available to and accessible by) collaborators that are not associated with the workspace. While in some embodiments of the invention, following the chat session the documents and comments will be made available to the collaborator or collaborators associated with the workspace, who may then share the documents and comments with other collaborators, in some embodiments of the invention the instant messaging agent may share the documents and comments automatically with all of the collaborators that participated in the chat session that the instant messaging agent monitored.

To store and share information in a workspace, an instant messaging agent may be implement with an Application Programming Interface (API) to communicate with the data storage service. The API may provide the instant messaging agent access to one or more tools and/or functions of the data storage service, including storing and sharing tools. To store and share information in the workspace, the instant messaging agent may execute one or more API function calls to store the information in the workspace.

It should be appreciated that embodiments of the invention are not limited to implementing the exemplary process shown in FIG. 3, and that embodiments of the invention may implement any suitable process for monitoring a chat session. For example, in some embodiments of the invention, the instant messaging client may monitor the chat session silently, and may not send notifications to the collaborators such as the notifications of blocks 306 and 312. Further, in some embodiments of the invention the instant messaging agent may not be invited to a chat session as in block 304, but may instead be configured, for example, to monitor all chat sessions in which a particular collaborator participates, and these embodiments of the invention may therefore implement a process 300 without blocks 302 and 304.

Further, in some embodiments of the invention, the instant messaging agent may be a more active participant in a chat session, and therefore the process 300 may comprise other acts to exchange information such as instructions and/or data between collaborators and the instant messaging agent. For example, in some embodiments of the invention a collaborator may be able to instruct the instant messaging agent to transmit to either the collaborator or all collaborators in the chat session a listing of information stored in a workspace with which the instant messaging agent is associated or may be able, in some embodiments of the invention, to instruct an instant messaging agent to transmit one or more documents and/or comments stored in a workspace to one or more collaborators participating in the chat session. It should be appreciated that these examples of instructions and data are merely illustrative, and that collaborators and instant messaging agents may exchange any suitable information (e.g., instructions and/or data) during a chat session.

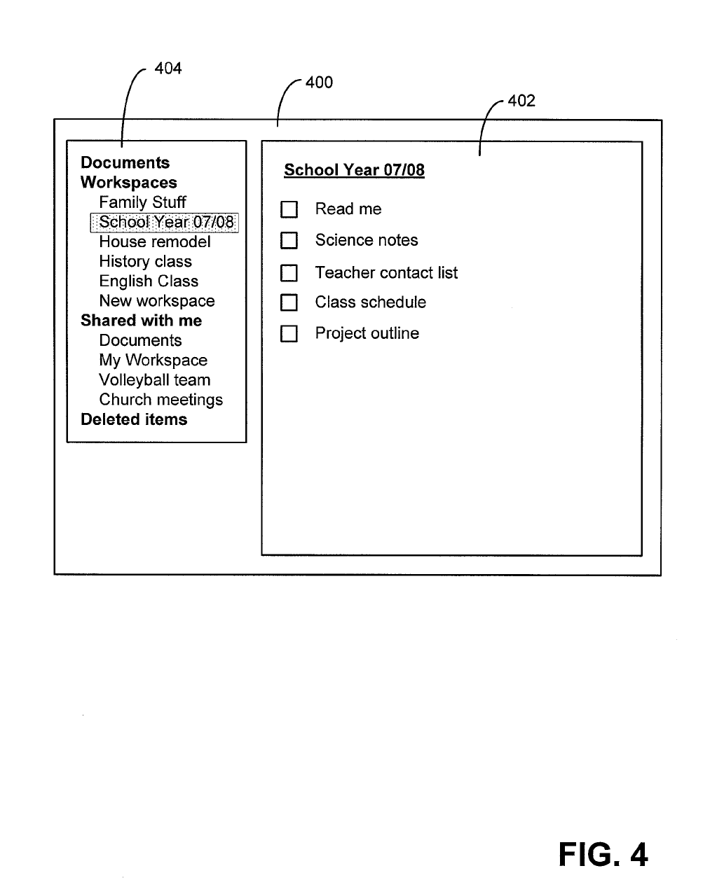

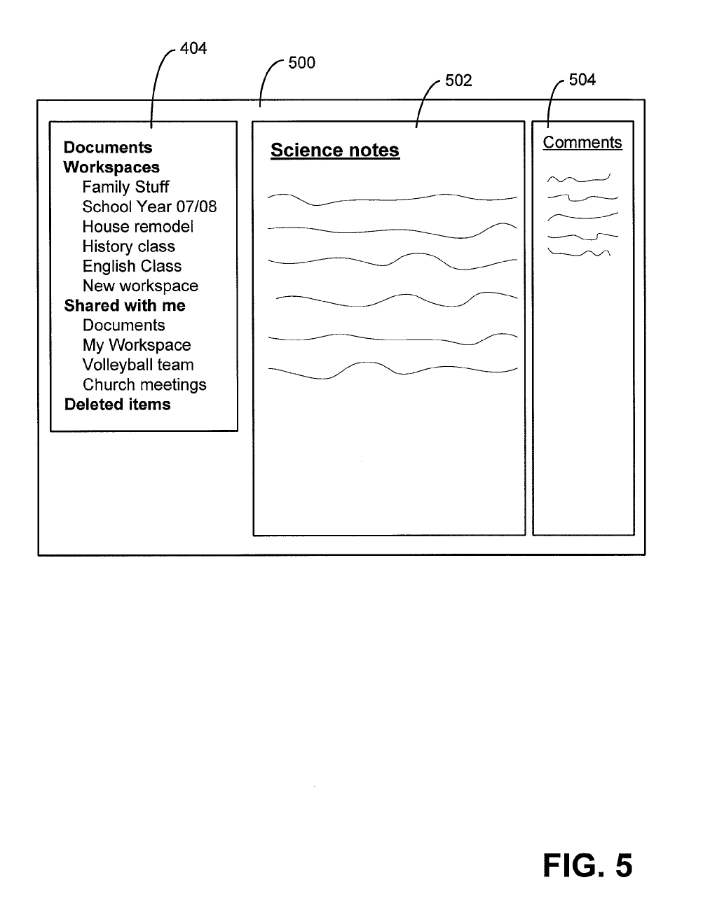

Collaborators may interact with a workspace stored by the data storage service in any suitable way. In one embodiment of the invention, collaborators may use a graphical user interface to access the information stored by a workspace. Some embodiments of the invention that implement a graphical user interface to allow users to access information in a workspace may implement the graphical user interface as a web site. FIGS. 4 and 5 show exemplary graphical user interfaces that may be implemented by embodiments of the invention.

The exemplary graphical user interface 400 of FIG. 4 shows two main regions: a central content panel 402 and a left navigation bar 404. In the graphical user interface 404, the central panel 402 is shown displaying the contents of a particular workspace that is highlighted in the left navigation bar 404. The selected workspace has been titled “School Year 07/08” and is shown in the content panel 402 comprising a plurality of documents such as “Science notes” and “Teacher contact list.” The left navigation pane 404 further comprises a listing of other workspaces available to the user logged into the web site, such as “Family stuff” and “House remodel.” Workspaces shown in the left navigation panel 404 may be workspaces that were created by a collaborator and/or may be workspaces that were shared with the collaborator. Each workspace may have a plurality of unique files stored in the workspace that may be displayed in the content panel 402 when a collaborator selects the workspace in the left navigation bar 404.

FIG. 5 shows an exemplary graphical user interface 500 that may be implemented by embodiments of the invention for displaying to a user the contents of a document stored in a workspace. In graphical user interface 500, a user, previously having selected a workspace in the left navigation bar 404 and having selected a document stored in the workspace from the content panel 402, may view in central panel 502 the contents of the selected document. In addition to showing the contents of the selected document, the graphical user interface shows in right-side panel 504 comments that have been associated with the document. The comments shown in right-side panel 504 may have been entered into the graphical user interface 500 directly, or may have been stored in the workspace in association with the document by the instant messaging agent as part of a chat session monitoring operation such as the ones discussed above.

It should be appreciated that embodiments of the invention are not limited to implementing the exemplary graphical user interfaces shown in FIGS. 4 and 5, and that embodiments of the invention may implement any suitable graphical user interface. Additionally, it should be appreciated that embodiments of the invention may implement any suitable technique to allow a collaborator to access information stored in a workspace and that embodiments of the invention may not implement a web site.

As discussed above, the embodiments of the invention described herein relating to a data storage service integrated with instant messaging software may be implemented on any suitable computer system. Exemplary implementations of computing devices 102 and 104, instant messaging server 106, and data storage server 108 (FIG. 1) are described below, though it should be appreciated that these implementations are merely illustrative, and other implementations are possible.

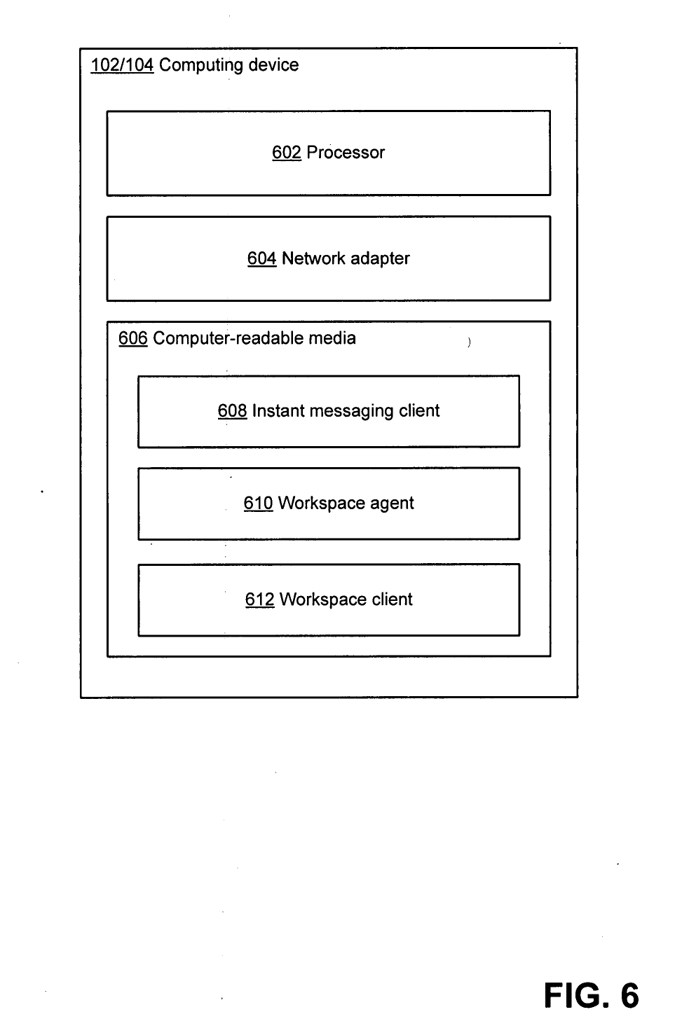

FIG. 6 shows an exemplary implementation of a computing device 102/104 that may be operated by a collaborator in accordance with one or more embodiments of the invention. It should be appreciated that FIG. 6 is intended to be neither a depiction of necessary components for a computer apparatus to operate as a computing device with embodiments of the invention, nor a comprehensive depiction. As discussed above, any suitable computer apparatus may be used by a collaborator as a computing device 102/104 to exchange information in a collaboration system. Computing device 102/104 may be a computing device designed for multiple purposes and for use by a user, such as a desktop personal computer, a laptop personal computer, a server, a personal digital assistant (PDA), a smart mobile telephone, or any other suitable electronic device.

As shown in FIG. 6, computing device 102/104 comprises a processor 602, a network adapter 604, and computer-readable media 606. Network adapter 604 may be any suitable hardware and/or software to enable computing device 102/104 to communicate with any other suitable computing device over any suitable computer network, such as communication network 100. The computer network may be any suitable wired and/or wireless communication medium or media for exchanging data between two or more computers, including the Internet and/or an enterprise network. Computer-readable media 606 may be adapted to store data to be processed and/or instructions to be executed by processor 602. Processor 602 enables processing of data and execution of instructions. The data and instructions may be stored on the computer-readable media 606 and may, for example, enable communication between components of the computing device 102/104.

In accordance with some embodiments of the invention, the data and instructions stored on computer-readable media 606 may comprise an instant messenger client 608. Instant messenger client 608 may be implemented as known in the art of in any other suitable way. Instant messenger client 608 may allow a collaborator operating the computing device 102/104 to perform any suitable operations related to an instant messenger environment, including one or more of allowing a collaborator to initiate a chat session, join a chat session, invite other collaborators to join a chat session, invite an instant messenger agent to monitor the chat session, send and/or receive information (e.g., documents and comments) to other collaborators in a chat session, end a chat session, and/or any other suitable operation(s). When a collaborator sends information to other collaborators in a chat session, the instant messenger client 608 may transmit the information directly to other collaborators participating in a chat session (i.e., directly to the computing devices the other collaborators are operating) or may transmit the information to an instant messaging server 106 that may process the information prior to relaying it to the other collaborators participating in the chat session.

In some embodiments of the invention, a computing device 102/104 may comprise a workspace agent 610 that acts as the instant messenger agent. The workspace agent 610 may monitor and store information exchanged during a chat session and send that information to a data storage server either during the chat session or after the chat session has ended. In embodiments of the invention implementing a workspace agent 610, inviting an instant messenger agent to participate in a chat session may comprise enabling a workspace agent 610 executing on the collaborator's computing device 102/104 which may then monitor the chat session as described above in conjunction with FIG. 3 or in any other suitable manner. Once a chat session has ended, the information may be stored on a data storage server and the workspace agent 610 may manage (e.g., share) that information on the data storage server in any suitable manner. It should be appreciated that some embodiments of the invention may not include a workspace agent 610 on a computing device 102/104 to monitor a chat session. Alternatively or additionally, an instant messenger agent may be implemented on another device such as on an instant messaging server 106 and a data storage server 108, as will be discussed in greater detail below.

A computing device 102/104 may further comprise a workspace client 612 to allow a collaborator to access information stored in a workspace on the data storage server 108. A workspace client 612 may be implemented in any suitable manner. For example, a workspace client 612 may be implemented as an application on the computing device 102/104 that the collaborator may execute to access the data, or, as another example, may be implemented as a web browser that may access a web site providing a graphical user interface to information stored in the workspace. Embodiments of the invention are not limited to implementing a workspace client 612 in any specific manner, as embodiments of the invention may implement a workspace client 612 in any suitable way.

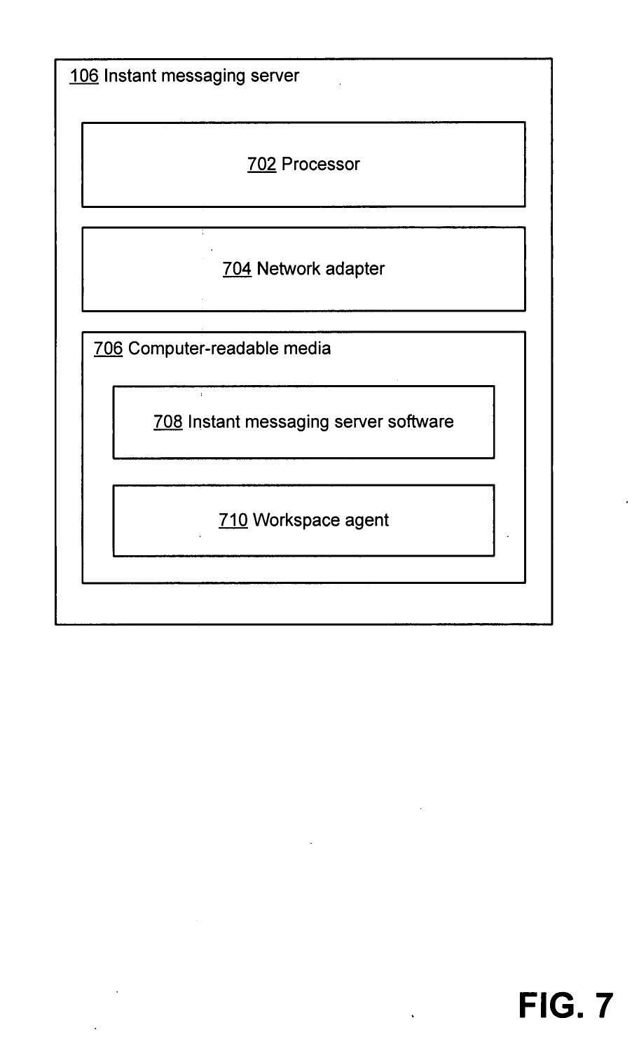

FIG. 7 shows an exemplary instant messaging server 106 that may be implemented in accordance with embodiments of the invention. It should be appreciated that FIG. 7 is intended to be neither a depiction of necessary components for a computer apparatus to operate as an instant messaging server with embodiments of the invention, nor a comprehensive depiction. As discussed above, any suitable computer apparatus or group of computer apparatus sharing processing and storage resources may be used as a instant messaging server 106 to process and relay information exchanged in a collaboration system. For example, an instant messaging server 106 may be implemented as a mainframe computer or a desktop personal computer, or any other suitable electronic device.

As shown in FIG. 7, instant messaging server 106 comprises a processor 702, a network adapter 704, and computer-readable media 706. Network adapter 704 may be any suitable hardware and/or software to enable instant messaging server 106 to communicate with any other suitable computing device over any suitable computer network, such as communication network 100. The computer network may be any suitable wired and/or wireless communication medium or media for exchanging data between two or more computers, including the Internet and/or an enterprise network. Computer-readable media 706 may be adapted to store data to be processed and/or instructions to be executed by processor 702. Processor 702 enables processing of data and execution of instructions. The data and instructions may be stored on the computer-readable media 706 and may, for example, enable communication between components of the instant messaging server 106.

In accordance with some embodiments of the invention, the data and instructions stored on computer-readable media 706 may comprise instant messaging server software 708. Instant messaging server software 708 may be any suitable software for managing one or more chat sessions being held in a collaboration system. Instant messaging server software 708 may receive requests to initiate chat sessions and may allocate processing and storage resources of instant messaging server 106 to handle the chat session and provide to a collaborator requesting initiation of a chat session an indicator that a chat session has been started. If the instant messaging server 106 does not have sufficient resources to manage the chat session (e.g., because a limit on a number of simultaneous chat sessions has been reached) then the instant messaging server software 708 may provide to a collaborator a notification that the chat session has not been started. After a chat session has started, instant messaging server software 708 may receive and relay to collaborators invitations to chat sessions and may store in a data store a listing of collaborators that have joined a chat session. When information is exchanged between collaborators in the chat session, it may be transmitted from a computing device 102/104 to the instant messaging server, which may process the information to determine to where it should be relayed (i.e., which collaborators should receive the information). Processing information to determine to where it should be relayed may comprise examining the data store of collaborators participating in chat sessions.

As discussed above, in embodiments of the invention an instant messaging agent associated with a data storage service may participate in a chat session and store information exchanged in the chat session in a workspace. In some embodiments of the invention, when an instant messaging agent is participating in a chat session, the instant messaging server software 708 may relay the information to an instant messaging agent executing on a data storage server 108 just as with any other collaborator participating in the chat session. In alternative embodiments of the invention, the instant messaging server software 708 may detect when an instant messenger agent is participating in a chat session and pass the information to a workspace agent 710 to relay the information to the instant messenger agent. In some embodiments of the invention, the instant messaging server software may determine whether an instant messaging agent is participating in a chat session by examining the usernames of collaborators participating in a chat session. For example, in embodiments of the invention implemented a collaboration system using the Windows® Messenger™ software, if the username of a collaborator participating in a chat session is an e-mail address ending in office.live.com, the instant messaging server software 708 may determine that the collaborator is an instant messaging agent.

An instant messaging agent participating in a chat session in some embodiments of the invention may be a workspace agent 710. Workspace agent 710 or instant messaging server 106 may transmit the information exchanged during a chat session to the data storage server 108. Transmitting the information to the data storage server 108 may be done in any suitable way. In some embodiments of the invention, the information is transmitted to the data storage server 108 using a web service such as the Simple Object Access Protocol (SOAP). Information may be transmitted over the web service as it is received by the instant messaging server software, or several pieces of information may be aggregated and transmitted, as this may, in some collaboration systems, increase efficiency. Information may be aggregated for transmission in any suitable manner. For example, information for a particular chat session being managed by the instant messaging server software 706 may be aggregated and transmitted by the workspace agent 710 once a condition has been met, such as a specified amount of time has elapsed since the last transmission or a specified amount of information has been aggregated. As another example, information exchanged during a plurality of chat sessions managed by the instant messaging server software 708 may be aggregated with an indicator of a chat session in which it was exchanged or a workspace in which it should be stored, and the workspace agent 710 may transmit the data once a condition has been met, such as a specified amount of time has elapsed since the last transmission or a specified amount of information has been aggregated. In the embodiments of the invention which aggregate information prior to transmission using a web service, information may be aggregated in any suitable manner.

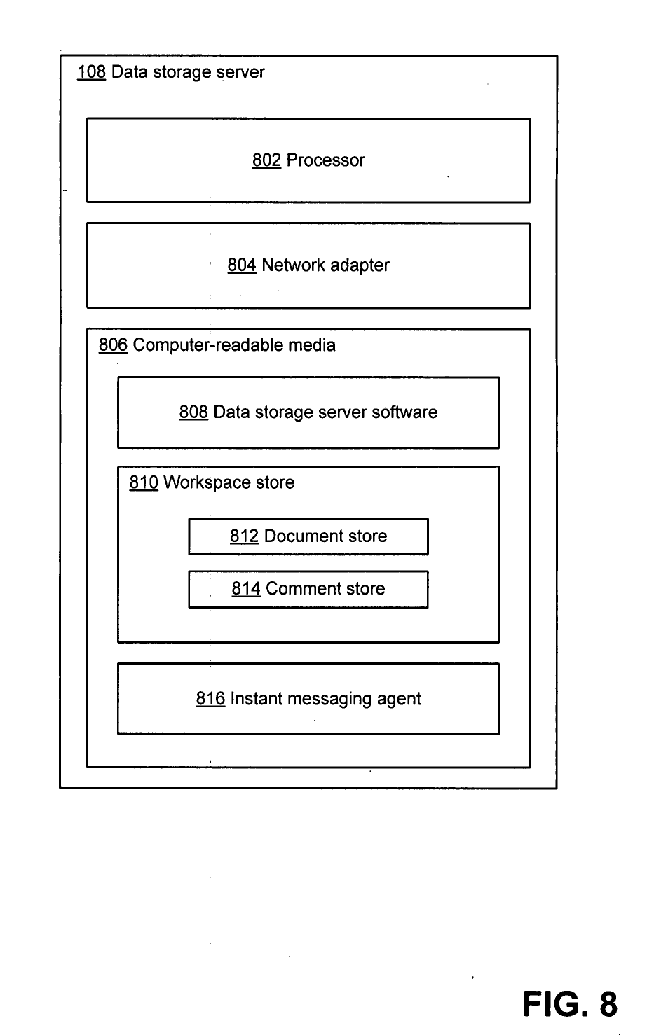

FIG. 8 shows an exemplary data storage server 108 that may be implemented in accordance with embodiments of the invention. It should be appreciated that FIG. 8 is intended to be neither a depiction of necessary components for a computer apparatus to operate as an data storage server 108 with embodiments of the invention, nor a comprehensive depiction. As discussed above, any suitable computer apparatus or group of computer apparatus sharing processing and storage resources may be used as a data storage server 108 to store information exchanged in a collaboration system. For example, a data storage server 108 may be implemented as a mainframe computer or a desktop personal computer, or any other suitable electronic device.

As shown in FIG. 8, data storage server 108 comprises a processor 802, a network adapter 804, and computer-readable media 806. Network adapter 804 may be any suitable hardware and/or software to enable data storage server 108 to communicate with any other suitable computing device over any suitable computer network, such as communication network 100. The computer network may be any suitable wired and/or wireless communication medium or media for exchanging data between two or more computers, including the Internet and/or an enterprise network. Computer-readable media 806 may be adapted to store data to be processed and/or instructions to be executed by processor 802. Processor 802 enables processing of data and execution of instructions. The data and instructions may be stored on the computer-readable media 806 and may, for example, enable communication between components of the data storage server 108.

In accordance with some embodiments of the invention, the data and instructions stored on computer-readable media 806 may comprise data storage server software 808 managing a data storage server. The data storage server may have one or more users each having an account with the data storage server, and each user may have one or more workspaces in which they may store data. The data storage server software 808 may comprise an interface for allowing the one or more users to access information stored in the one or more workspaces. In some embodiments of the invention, the interface implemented by the data storage server software 808 may be a web site such as the web sites shown in FIGS. 4 and 5.

The computer-readable media 806 may further comprise a workspace store 810 storing one or more workspaces 112. A workspace of the one or more workspaces 112 may be associated with (e.g., managed by) one or more collaborators, and/or store one or more pieces of information (e.g., documents) that are each associated with one or more other collaborators that may be the same as or different from the one or more collaborators associated with the workspace.

In some embodiments of the invention, each workspace may comprise a document store 812 to store documents and a comment store 814 to store comments. As discussed above, however, in alternative embodiments of the invention documents and comments may be stored in a single data store and may be stored in association with one another. For example, the workspace store 810 may store a document and may store comments about the document such that they are associated with the document or may store the comments about the document in a separate document in the same data store.

As discussed above, in some embodiments of the invention the data storage server 108 may store information exchanged between collaborators in a chat session. The information exchanged between the collaborators may comprise documents and/or comments. In some embodiments of the invention which store information exchanged in a chat session on a data storage server 108, the computer-readable media 806 may comprise an instant messenger agent 816. The instant messenger agent 816 may be invited to participate in a chat session and may monitor the chat session and store information exchanged during the chat session in a designated workspace in workspace store 810. In some embodiments of the invention, instant messenger agent 816 may be implemented to receive the information directly from another collaborator or from instant messaging server 106 and store it in a workspace. In alternative embodiments of the invention, as discussed above, instant messaging server 106 may transmit information exchanged during a chat session with the data storage server 108 using a web service such as SOAP. In the embodiments of the invention implementing a web service, instant messenger agent 816 may be adapted to examine information received by the data storage server 108 over the web service to determine in which workspace it should be stored. In some embodiments of the invention, the instant messaging agent 816 may include an API to execute tools and functions of the data storage server software 808, such as storing and sharing information. In these embodiments of the invention, storing and sharing information in a workspace may comprise executing one or more API function calls.

As discussed above, a workspace may be associated with one or more users of the data storage server and may comprise one or more documents each associated with one or more other users, the one or more other users being the same as or different from the one or more users. In some embodiments of the invention, once information exchanged during a chat session is stored in a workspace, the instant messenger agent 816 may notify the data storage server software 808 that the documents and/or comments should be shared with one or more collaborators that participated in the chat session. The documents and/or comments added to the workspace may then be associated with one or more users of the data storage system that are associated with the one or more collaborators (e.g., the one or more collaborators are the one or more users of the data storage system).

While the instant messenger agent 816 is shown in FIG. 8 as a single agent, it should be appreciated that in some embodiments of the invention each workspace stored by the data storage server may be associated with an instant messaging agent adapted to monitor chat sessions and store information exchanged during the chat session in the workspace. In some embodiments of the invention implementing an instant messaging agent for each workspace, the instant messaging agent may be created and assigned an account (e.g., a username and/or any other suitable information) on the instant messaging server 106. In other embodiments of the invention, each user of the data storage server 108 may be associated with an instant messaging agent and may notify the instant messaging agent at the start of a chat session (or at any other suitable time) of the workspace in which the instant messaging agent should store the information exchanged during the chat session.

It should be appreciated that the exemplary implementations of a computing device 102/104, instant messaging server 106, and data storage server 108 shown in FIGS. 6-8 are merely exemplary, and the embodiments of the invention may implement a computing device 102/104, instant messaging server 106, and/or data storage server 108 in any suitable manner.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of operating a collaboration system comprising a workspace of a data storage service and an instant messaging agent to allow at least one collaborator to share information, the method comprising:
establishing an instant messaging agent associated with the workspace as a collaborator in a chat session;
sharing the information among the at least one collaborator and the instant messaging agent; and
storing, with the instant messaging agent, the information in association with the workspace.

2. The method of claim 1, wherein sharing the information comprises engaging in a chat session and transmitting a file.

3. The method of claim 2, wherein storing the information comprises storing the file and a record of the chat session in the workspace.

4. The method of claim 3, wherein storing the information comprises storing the record of the chat session as a set comments associated with the stored file.

5. The method of claim 3, wherein storing the information comprises storing the file and the record of the chat, session as separate files in the workspace.

6. The method of claim 1, further comprising automatically granting to the at least one collaborator access to the stored information.

7. The method of claim 6, further comprising, accessing, by at least a portion of the at least one collaborator, the stored information in the workspace.

8. A method of operating a collaboration system comprising a server and a plurality of client computers, the method comprising:
establishing a workspace on the server for a collaborator using the collaboration system;
establishing an instant messaging chat session including instant messaging clients on the plurality of client computers and an instant messaging agent that has access to the workspace on the server;
capturing, with the instant messaging agent, information exchanged in the chat session; and
storing the information exchanged in the chat session on the server associated with the workspace.

9. The method of claim 8, further comprising:
communicating from the instant messaging agent to the collaborator an indication that the instant messaging agent is capturing information exchanged in the chat session.

10. The method of claim 8, further comprising:
communicating from the instant messaging agent to the collaborator an indication that the instant messaging agent stored in the workspace a file exchanged in the chat session.

11. The method of claim 8, wherein:
establishing an instant messaging chat session including an instant messaging agent that has access to the workspace on the server comprises establishing the instant messaging agent as an instant messaging client on the server.

12. The method of claim 11, further comprising:
establishing a plurality of chat sessions and storing, for each of the plurality of chat sessions, information exchanged in the collaboration session in a workspace on the server.

13. The method of claim 12, wherein:
capturing with the instant messaging agent comprises capturing the information exchanged in the chat session for a plurality of the chat sessions with the same instant messaging agent.

14. The method of claim 12, wherein:
capturing with the instant messaging agent comprises capturing the information exchanged during a chat session for a plurality of the chat sessions with a workspace agent associated with the instant messaging system.

15. The method of claim 12, wherein:
capturing with the instant messaging agent comprises capturing the information exchanged in a chat session for each of a plurality of the chat sessions with a separate instant messaging agent associated with an instant messaging client in the chat session.

16. Computer-readable media having computer-executable instructions for implementing a collaboration system allowing collaboration among at least one collaborator, the computer-executable instructions, when executed, performing steps comprising:
maintaining a workspace on a server under control of a workspace user that is a collaborator of the at least one collaborator, the workspace providing storage for a plurality of artifacts accessible to the workspace user and secondary users designated by the workspace user;
broadcasting real-time messages between the at least one collaborator;
automatically capturing and storing the real-time messages in the storage of the workspace; and
designating at least a portion of the at least one collaborators as secondary users of the workspace.

17. The computer-readable media of claim 16, wherein:
the computer-executable instructions for maintaining a workspace on a server implement a web service providing an interface through which captured real-time messages may be stored in the storage.

18. The computer-readable media of claim 16, wherein:
the computer-executable instructions for broadcasting real-time messages comprise a plurality of instant messaging clients, each instant messaging client associated with a client computer used by a collaborator of the at least one collaborator.

19. The computer-readable media of claim 17, further comprising:
computer-executable instructions for performing word processing and list processing functions in a computer-readable medium associated with each of the plurality of client computers.

20. The computer-readable media of claim 16, wherein
the computer-executable instructions for broadcasting real-time messages comprise computer-executable instructions for broadcasting chat text and a file;
the computer-executable instructions for maintaining a workspace comprise computer-executable instructions for presenting a user interface comprising a document viewing pane and a comment pane; and
the computer-readable media further comprises computer-executable instructions that when executed, perform steps comprising:
displaying the file in the document viewing panel and
displaying the chat text in the comment pane.
